(19) United States
(12) Patent Application Publication
(10) Pub. No.: US 2008/0302442 A1
(43) Pub. Date: Dec. 11, 2008

(54) Magnetic Holding Device for Tank Closure Caps

(76) Inventor: Antonio Miceli, Hitchin (GB)

Correspondence Address: WILLIAM D. HALL, 10850 STANMORE DR, POTOMAC, MD, 20854, US

(21) Appl. No.: 11/885,094

(22) PCT Filed: Feb. 28, 2006
(86) PCT No.: PCT/GB06/00709

§ 371 Date: Aug. 4, 2008

(30) Foreign Application Priority Data
Feb. 28, 2005 (GB) 0503984.7
Jul. 22, 2005 (GB) 0515084.2

(51) Int. Cl. B67D 5/37; B60K 15/04

(52) U.S. Cl. 141/311 R; 141/1

(57) ABSTRACT

An apparatus and method for indicating that a flowable material to be put into a container has been correctly selected comprising a cap (12) for the container for the flowable material, a first magnet (14) of the cap (12), and a second magnet at a surface for co-operation with the first magnet (14). The cap is preferably a fuel cap of a motor vehicle and the surface is a surface of a fuel pump (16) having a fuel nozzle. The second magnet is either located at a portion of a handle of the fuel nozzle or on the main body of the fuel pump (16) in the form of a rectangular strip (18) which can be used as an advertising platform.

This invention relates to caps for containers for holding a flowable material and, in particular, to such caps which include magnetic material.

In relation to motor vehicles, when fuel is needed and a person puts fuel into their vehicle at a fuel station, it is very frustrating if the wrong kind of fuel is put into the vehicle and it is very expensive to correct the error. This problem is commonly known as mis-fuelling and, in the United Kingdom alone, around 120,000 vehicles per year are stranded after putting in the wrong fuel in the vehicle's fuel tank and have to pay up to £3,000 to get their vehicles back on the road, especially if the vehicle has been driven after the mistake of mis-fuelling.

Company car drivers are known to be among the main culprits of mis-fuelling, especially those who use pool or hire vehicles on a regular basis. In addition, the most common cause of mis-fuelling is putting petrol into a vehicle that runs on diesel and the most regular occurrences occur when people who are driving for business purposes regularly are unfamiliar with vehicles such as hire cars. Petrol being put into diesel vehicles is likely to be the most common form of mis-fuelling since the narrower nozzles of petrol pumps fits into the wider diesel aperture on a vehicle, and since the popularity of modern diesel vehicles has increased in recent years, this problem of mis-fuelling occurs more frequently.

Furthermore, it is not just fuel that is wasted in correcting a mis-fuelling. The cost of repairing a mis-fuelled vehicle, as already mentioned, can be thousands of pounds sterling and just two drivers mis-fuelling in a year could dent a fleet budget by more than ±10,000 in the worst case scenario. If the vehicle is not started after the mis-fuelling mistake, the repair simply needs the fuel to be drained and the fuel system flushed and is not as costly to repair compared to if the driver starts the engine, such that the repair is likely to include the replacement of such things as injection components, fuel and filters.

Mis-fuelling can also render the vehicle warranty invalid, which is clearly of great inconvenience to the vehicle user.

Devices to prevent mis-fuelling already exist. One such device includes a component which attaches to the inside of a vehicle fuel flap and, when the fuel flap is opened, the device emits an audible warning message to remind a driver that the vehicles runs on diesel fuel.

According to one aspect of the present invention, there is provided apparatus comprising a cap for a container for flowable material, a first magnet of said cap, and a second magnet at a surface for co-operation with said first magnet.

According to a second aspect of the present invention, there is provided a method comprising bringing a cap for a container for flowable material to a surface, and thereby causing co-operation between a first magnet of said cap and a second magnet at a surface.

Owing to these two aspects of the invention, a magnet of a cap of a container for the flowable material can co-operate with a magnet at a surface in order to cause attraction between the two magnets.

Advantageously, the surface is one on a dispensing unit for the flowable material, and the co-operation between the first and second magnets indicate that a flowable material to be put into the container has been correctly selected.

Preferably, the cap is a fuel cap of a motor vehicle and the container for flowable material is a fuel tank of the vehicle which requires, for instance, either petrol or diesel fuel. In addition, the dispensing unit is preferably a fuel pump comprising nozzles for both petrol and diesel fuel, and attraction between the first magnet of the fuel cap when placed in the region of the second magnet of the dispensing unit informs the person putting fuel into the vehicle that the correct fuel is being used. Conversely, if there is repelling between the first and second magnets, then the person entering fuel into the vehicle is informed before fuel is entered into the vehicle that the nozzle associated with the second magnet will dispense fuel which is incorrect for that particular vehicle.

The first and second magnets may be of any suitable type, and in particular consideration of the second magnet, it could be, for example a permanent magnet, an electromagnet or a solenoid coil.

In order that the invention may be clearly and completely disclosed, reference will now be made, by way of example only, to the accompanying drawings, in which:

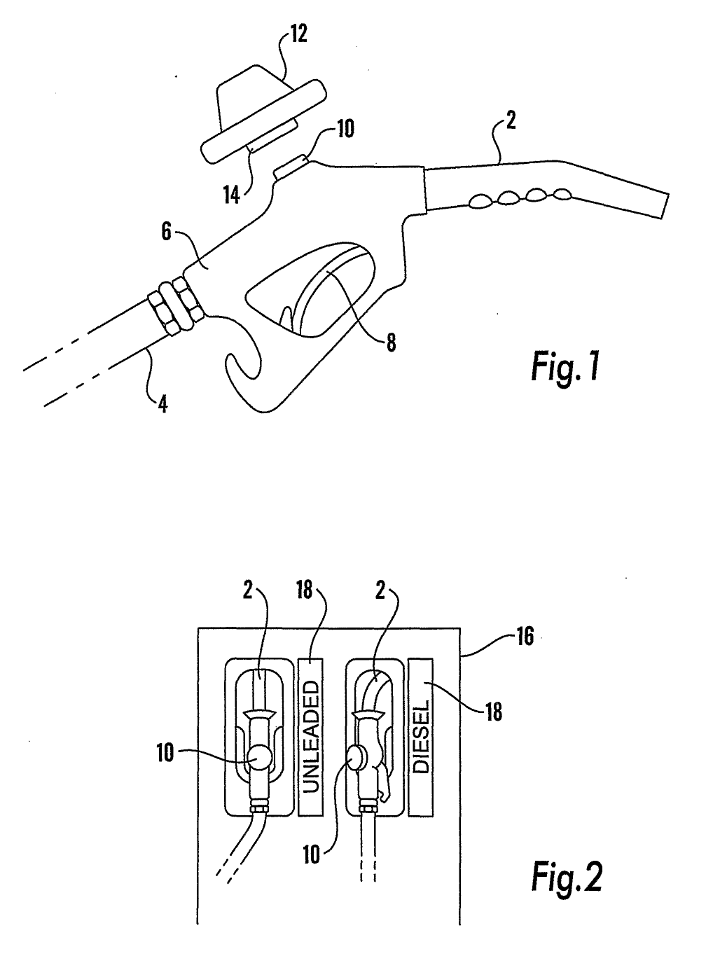

FIG. 1 shows a side view of a fuel filling nozzle of a fuel pump and a fuel cap of a vehicle according to a first version of a fuel filling system, and

FIG. 2 shows a front elevation of a fuel pump according to a second version of the fuel filling system.

Referring to FIG. 1, a first version of a fuel filling system comprises a filling nozzle 2 attached to a fuel pump by a hose 4 and includes the standard features of conventional nozzles such as a handle 6, a trigger 8 and a disc 10 which, conventionally, includes some kind of graphical information. A fuel cap 12 of a motor vehicle, on its outer surface, includes a first magnet 14. In addition to the disc 10 of the filling nozzle 2 containing graphical information, it also includes a second magnet.

If the fuel cap 12 is from a car which runs on unleaded petrol, the magnet 14 is of a particular magnetic field which is attractive to the magnet at the disc 10 of a filling nozzle 2 if that particular nozzle is for filling the vehicle with unleaded fuel. Therefore, if the person filling the vehicle with fuel is using the correct nozzle for unleaded petrol, and he brings together the magnets 14 and 10, then the fuel cap 12 will magnetically attract and thereby stick to the disc 10. On a corresponding filling nozzle for diesel fuel the disc 10 shall comprise a magnet which would cause a fuel cap 12 from an unleaded vehicle to be repelled away from the handle 6 of a nozzle 2 for dispensing diesel fuel. Since the fuel cap 12 of an unleaded petrol car will therefore not stick to the handle 6 of a diesel filling nozzle 2, this immediately informs the person putting fuel into the vehicle that he is about to use the wrong fuel. Similarly, when the fuel cap 12 for a diesel vehicle is placed on the disc 10 of a diesel filling nozzle 2, there will be attraction of the magnets such that the fuel cap sticks to the handle 6, and, if the diesel fuel cap 12 is brought against the disc 10 of a filling nozzle 2 for dispensing unleaded petrol, there will be repelling of the magnets to prevent mis-fuelling.

The magnets may be bar magnets incorporated in the cap 12 and the disc 10 having opposite north-seeking and south-seeking poles, such that in the fuel cap 12 for an unleaded petrol vehicle it could have its south-seeking pole at the external surface of the cap, such that the disc 10 of an unleaded filling nozzle 2 would have a corresponding magnet with a north-seeking pole facing outwardly. Therefore, when a fuel cap 12 of an unleaded petrol vehicle is placed onto the disc 10 of the unleaded filler nozzle 2, the magnets will attract each other and the fuel cap 12 will stick to the filler nozzle 2. On the other hand, a fuel cap 12 for a diesel vehicle would have a similar magnet, but with the north-seeking pole facing outwardly and the filler nozzle for diesel fuel would have a corresponding magnet with its south-seeking pole extending outwardly, such that when the diesel fuel cap 12 is placed against the disc 10 of the diesel filler nozzle, the magnets will attract each other. If, however, a fuel cap 12 for a diesel vehicle is placed against the disc 10 of a filler nozzle 2 for dispensing unleaded petrol, the poles of the magnets facing each other are the same and, thus, will repel each other. As a result, the fuel cap 12 will not stick to the disc 10 which informs the user that they are about to use the wrong fuel.

The magnets may also be in the form of thin pieces of permanent magnets. In this way, the magnets 14 on the fuel cap 12 may be incorporated into the fuel cap 12 itself, as described above or be adhesive such that the magnet of the cap 12 could be supplied separately from the fuel cap 12 itself and simply stuck using an adhesive onto the external surface of the fuel cap 12 by the user of the vehicle. The disc 10 of the filler nozzle 2 could also similarly comprise a thin-form magnet.

Instead of the disc 10 of the filler nozzle 2 comprising a magnet, which disc 10 does not have a large surface area, a magnet in the form of a thin rectangular strip can be provided at the fuel pump as shown in FIG. 2. A fuel pump 16 has two filler nozzles 2, one for unleaded petrol and one for diesel fuel, both shown in the non-use position hooked onto the pump 16. As a person re-fuelling a vehicle looks at the pump 16, to the right-hand side of the nozzles 2 a rectangular magnet strip 18 is provided suitably attached to the external surface of the pump 16. These magnet strips 18 have a larger surface area than the discs 10 of the nozzles 2 and have magnetic fields arranged to work in the same way as already described to prevent mis-fuelling incidents. An advantage of the magnet strips 18 is that, not only can they indicate which type of fuel is available from the nozzle 2 located immediately adjacent to it, but also can display other graphical information, such as advertising.

This fuel filling system also has the advantage that the fuel cap 12 is magnetically connected to either the filler nozzle 2 or the dispensing pump unit 16 so that the fuel cap 12 can be kept in place rather than rolling about on a surface where it is placed. In the situation where a fuelling station does not have the present fuel filling system, and, if the vehicle fuel cap cover does not have its own fuel cap locator, a further appropriate magnet can be attached to the inside surface of the fuel cap cover and then the fuel cap 12 incorporating the magnet 14 can be attached to the cover where the further magnet is located. The further magnet is also, advantageously, a thin magnet so as not to occupy a large volume of space.

Furthermore, in different countries around the World, different colours are used to represent different fuel types and, of course, different words are used for the different fuel types according to the local language. The present fuel filling system would solve any problems caused by representative colour and/or language confusion at a filling station.

1-16. (canceled)

17. Apparatus comprising a cap for a container for flowable material, a first magnet of said cap, and a second magnet at a surface for co-operation with said first magnet.

18. Apparatus according to claim 17, where said cap is a fuel cap of a motor vehicle.

19. Apparatus according to claim 17, wherein said surface is a surface of a dispensing unit of said material.

20. Apparatus according to claim 19 wherein said container for flowable material is a fuel tank of said motor vehicle and said dispensing unit is a fuel pump comprising a fuel nozzle.

21. Apparatus according to claim 20 wherein said second magnet is located at a portion of a handle of said nozzle.

22. Apparatus according to claim 17, wherein said first and second magnets are of a thin form.

23. Apparatus according to claim 17, wherein said first magnet is detachably connected to said fuel cap.

24. Apparatus according to claim 22, wherein said second magnet is in the form of a thin rectangular strip.

25. Apparatus according to claim 24, wherein the rectangular strip is an advertising platform.

26. Apparatus according to claim 22, wherein said first magnet is detachably connected to said fuel cap and said second magnet is in the form of a thin rectangular strip.

27. Apparatus according to claim 18, and further comprising a further magnet at an inside surface of a fuel cap cover of said motor vehicle.

28. Apparatus according to claim 27, wherein said further magnet is of a thin form.

29. A method comprising bringing a cap for a container for flowable material to a dispensing unit for said material, and thereby causing co-operation between a first magnet of said cap and a second magnet at a surface.

30. A method according to claim 29, where said cap is a fuel cap of a motor vehicle.

31. A method according to claim 29, wherein said surface is a surface of a dispensing unit of said material.

32. A method according to claim 31, wherein said container for flowable material is a fuel tank of said vehicle and said dispensing unit is a fuel pump comprising a fuel nozzle.

33. A method according to claim 2, wherein said co-operation includes attraction between said first and second magnets thereby informing a user that said flowable material for said container has been correctly selected.
